(19) United States
(12) Patent Application Publication
(10) Pub. No.: US 2003/0145190 A1
(43) Pub. Date: Jul. 31, 2003

(54) Compiler algorithm to implement speculative stores

(76) Inventor: Paolo Faraboschi, Brighton, MA (US)

Correspondence Address: HEWLETT-PACKARD COMPANY, Intellectual Property Administration, P.O. Box 272400, Fort Collins, CO, 80527-2400, US

(21) Appl. No.: 10/004,891

(22) Filed: Dec. 7, 2001

(51) Int. Cl. G06F 15/00

(52) U.S. Cl. 712/234

(57) ABSTRACT

Apparatus for transforming computer software having a branch operation for conditionally bypassing a memory write operation. The apparatus includes computer executable program code stored in one or more computer readable storage media. The computer executable program code includes code for creating a storage location, code for moving the memory write operation above the branch operation, code for selecting a target address for the memory write operation, wherein the storage location is selected if the branch operation bypasses the memory write operation, and code for replacing an address in the memory write operation with the target address.

### FIELD OF THE INVENTION

This invention relates generally to computer software compilers and more specifically to a compiler algorithm to implement speculative stores for conditional memory write operations in non-fully predicated architectures.

### BACKGROUND

As is generally known, computers are used to manipulate data under the control of software. A central processing unit (CPU, or processor) in the computer reads and executes instructions in the software to manipulate the data in order to perform some useful task. Computer executable instructions are typically made up of numeric codes, or operation codes (opcodes), each corresponding to a particular operation, such as an add operation. Each opcode may be followed by one or more operands, or parameters to the opcode. Writing computer programs directly in this machine language format, made up entirely of a series of numbers, would be extremely difficult. Therefore, computer programs are nearly always written in a more easily readable language. For example, even a low level programming language such as Assembly replaces the numeric opcodes with abbreviations or mnemonic codes such as “add” or “load.” However, software developers have increasingly turned to programming in high level languages like C or C++ which is much more humanly readable. The high level source code is then compiled by a compiler to convert it to machine language binary programs. High level source code is very hardware independent in that the same source code can be compiled by different compilers for various types of computer hardware, and it is the compiler which translates the high level source code into machine language instructions suitable for a particular computer processor. Since high level languages are largely hardware independent, they do not provide the programmer with much control over the final structure of resulting machine language code, so compilers are designed to perform many optimizations to produce programs which are as efficient as possible during execution. For example, it is the compiler which determines the set of opcodes to use to implement a given set of instructions in high level source code, and some opcodes may be more efficient than others on a given type of processor.

Computer processor designs have also evolved to become faster and more efficient, precipitating changes in compiler design. The earlier prior art processors are typically single instruction single data (SISD) processors. A SISD processor typically receives a single instruction stream and a single data stream. The SISD processor sequentially executes each instruction, acting on data in a single storage area. This SISD processor architecture, however, presents an obstacle to achieving high processing throughput. To increase the processing throughput of a processor, many processing architectures which are more efficient have been developed. One type includes a technique known as pipelining which provides instruction-level parallelism by processing multiple instructions simultaneously.

However, frequent and unpredictable branch operations in program code lead to wasted instructions in pipelining processors. Pipelining is a method of fetching and decoding instructions (preprocessing) in which, at any given time, several program instructions are in various stages of being fetched or decoded. Ideally, pipelining speeds execution time by ensuring that the microprocessor does not have to wait for instructions; when it completes execution of one instruction, the next is ready and waiting. When the processor is executing an instruction, it is also fetching upcoming instructions. However, branch operations in a pipelining processor typically introduce branch latencies or mispredict penalties, thus causing the execution to stall at run-time. When the processor encounters a branch instruction, it must predict what the branch outcome will be when it is executed so that it can continue to fetch instructions after the branch instructions. If the branch prediction is incorrect, all the fetched instructions after the branch instruction are unused and execution stalls while the processor waits for the next instruction by draining the pipeline and undoing the effects of the improperly fetched instructions.

In order to eliminate branches and further enhance the instruction-level parallelism, an architectural model called a predicated architecture has been developed in which each processor operation is guarded by a boolean-valued source operand called the predicate or guard. The value of the predicate determines whether the operation is executed or nullified. From the viewpoint of the instruction set architecture, the main features of the predicated execution are a predicate guarding each operation and a set of compare-to-predicate operations used to compute predicates. Instructions are fetched along both paths of a branch, but execution of each fetched instruction is only completed if its predicate is true, otherwise the instruction is nullified and prevented from modifying the processor state. Thus, instructions fetched from the correct path of a branch have their predicates set to true, and instructions fetched from the incorrect path of a branch have their predicates set to false. The predicated execution typically eliminates the effects of misprediction completely for many branches. Unfortunately, fully predicated code, in which at least one predicate operand is added to each instruction in the entire program, adds a great deal of size and complexity.

Architectures can approximate the performance of full predication without paying the cost of full predication by using “conditional move” [if (a) b=c;] or “select” [if (a) b=c; else b=d;] operations. These techniques are sometimes called “partial predication.” Partial predication in combination with speculative execution enables if-conversion of large parts of programs even for architectures that do not have full predication support. For partially predicated architectures, a barrier to if-conversion is represented by memory write operations (stores).

A need therefore exists for a method of minimizing the impact of incorrect branch predictions for computer architectures lacking full predication. A further need exists for a method of removing branch operations in code for computer architectures lacking full predication. A further need exists for a compiler algorithm to implement speculative stores without control-flow dependencies for computer architectures lacking full predication. A further need exists for a method of performing if-conversion using partial predication for memory write operations.

### SUMMARY

The invention meets these and other needs by providing a compiler algorithm to implement speculative stores. A first exemplary embodiment can be described from the point of view of transforming an assembly version of a code segment which includes a conditional memory write operation, where the condition is controlled by a control-flow dependency. In this embodiment, the compiler creates a dummy location for each compilation unit. For a given conditional memory write, or store, operation in the compilation unit, the compiler moves the store operation above the controlling branch. The compiler then selects the address that the store operation uses based on the controlling branch, so that it selects the dummy location for one conditional result, or the original store location for the other conditional result. The compiler then replaces the address in the store operation with the selected address. Thus, the destination address for the store operation is speculative, and the compiler algorithm has replaced a control-flow dependency (with a branch) with a data-flow dependency (with a speculative store).

A second exemplary embodiment can be described from the point of view of compiling a high level code segment containing a conditional memory write operation to create an assembly version containing a data-flow dependency, not a control-flow dependency. In this embodiment, the compiler creates a dummy location, or local variable, for each compilation unit. For a given conditional store operation in the compilation unit, the compiler selects either the original address of the conditional store operation or the dummy address based on the result of the condition. The compiler then performs the store operation into the selected address. Thus, the compiler generates code with a data-dependency and no branch. This avoids the effects of branch mispredictions in computer architectures which are not fully predicated for code blocks having conditional memory write operations.

### BRIEF DESCRIPTION OF THE DRAWING

Illustrative and presently preferred embodiments of the invention are shown in the accompanying drawing, in which:

FIG. 1 is an exemplary block diagram illustrating a prior art computer system suitable for creating or executing a compiler algorithm to implement speculative stores;

FIG. 2 contains an exemplary code fragment written in the C programming language;

FIG. 3 contains a pseudo-Assembly language version of the exemplary code fragment of FIG. 2, showing the branch operation generated by a prior art compiler;

FIG. 4 is a flow chart of a general exemplary compiler algorithm to implement speculative stores;

FIG. 5 is a flow chart of an exemplary compiler algorithm to implement speculative stores;

FIG. 6 contains an exemplary high level version of a code fragment corresponding to the code fragment of FIG. 2 as it would be transformed by a compiler algorithm to implement speculative stores;

FIG. 7 contains a pseudo-Assembly language version of the exemplary converted code fragment of FIG. 6, using a select operation; and

FIG. 8 contains a pseudo-Assembly language version of the exemplary converted code fragment of FIG. 6, using a conditional move operation.

### DETAILED DESCRIPTION

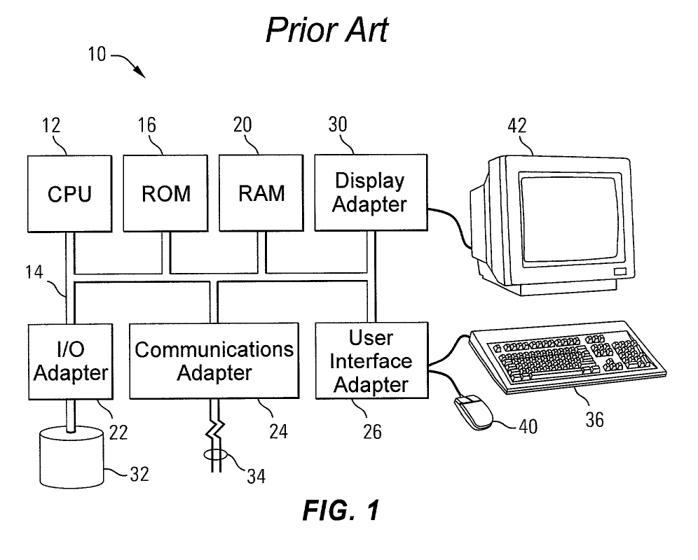

A typical computer system which may be used to implement portable run-time code synthesis in a caching dynamic translator is illustrated in the block diagram of FIG. 1. A computer system 10 generally includes a central processing unit (CPU) 12 connected by a system bus 14 to devices such as a read-only memory (ROM) 16, a random access memory (RAM) 20, an input/output (I/O) adapter 22, a communications adapter 24, a user interface adapter 26, and a display adapter 30. Data storage devices such as a hard drive 32 are connected to the computer system 10 through the I/O adapter 22. In operation, the CPU 12 in the computer system 10 executes instructions stored in binary format on the ROM 20, on the hard drive 32, and in the RAM 16, causing it to manipulate data stored in the RAM 16 to perform useful functions. The computer system 10 may communicate with other electronic devices through local or wide area networks (e.g., 34) connected to the communications adapter 24. User input is obtained through input devices such as a keyboard 36 and a pointing device 40 which are connected to the computer system 10 through the user interface adapter 26. Output is displayed on a display device such as a monitor 42 connected to the display adapter 30.

Before describing a compiler algorithm to implement speculative stores which can be created and executed on a computer system 10, some terms used in the description will be defined:

A “speculative store,” as the term is used in this description, is a memory write operation in which the address written to is speculative, that is, the address depends upon the result of a conditional test. Note, however, that a speculative store is executed each time through the code. The address stored in is speculative, but the execution of the store operation is not speculative.

A “control-flow dependency” occurs when an instruction's execution is conditioned upon the result of a branching instruction. Control-flow dependencies lead to possibly mispredicted branches, causing execution stalls in pipelining architectures.

A “data-flow dependency” occurs when the processing of an instruction must be completed before additional instructions may be executed to ensure that data is processed in the proper order. In a data-flow dependency, unlike a control-flow dependency, each instruction is executed, therefore there are no mispredicted branches (since there are no branch instructions) and the pipeline need never be emptied. In addition, machines with instruction-level parallelism can employ more aggressive scheduling techniques for code with data-flow dependencies than for code with control-flow dependencies.

A “conditional store” operation is a memory write instruction which is only performed if a condition is satisfied, e.g., if (a>0) *p=10. Thus, the value 10 is only stored at the address pointed to by p if a is greater than zero. Traditional compilers generate a control-flow dependency for the sample code above, jumping over the store operation if the condition is not satisfied, or is false.

“Functionally equivalent code” is code that performs the same function or task as another segment of code, although the instructions used to perform the task may be completely or partially different. For example, the conditional store operation described above may be performed in several functionally equivalent manners. One way, created by a traditional compiler, is based on a control-flow dependency, leading to mispredicted branches. Another way, created by the compiler algorithm to implement speculative stores, which is described herein, is based on a data-flow dependency with no branch operation. In each case, the code performs the function of storing a value if a condition is satisfied, thus they are functionally equivalent. However, one leads to possibly mispredicted branches and execution stalls, the other does not.

“High level code” is computer program code which is written in a high level programming language such as C or Pascal. High level code is easily readable but is largely hardware independent. Therefore it must be processed by a software tool such as a compiler before a computer can execute the code.

“Low level code” is computer program code which is written in a low level language such as Assembly, which must be processed by software tools such as an assembler and linker, or even machine language binary code, which may be directly executed by a computer.

A “local variable” is a variable which is only accessible within a limited scope, such as within a function, block or compilation unit.

A compiler algorithm to implement speculative stores, which can be executed on a computer system 10, produces program code having conditional write operations without using control-flow dependencies, which is beneficial for computer systems 10 that do not have fully predicated architectures. The algorithm may be adapted to any type of input and output code to if-convert any type of speculative store. The algorithm thus converts control-flow dependencies to data-flow dependencies, or avoids the creation of control-flow dependencies when compiling high level source containing conditional store operations. The algorithm reads program code as its input, such as low level code containing a control-flow dependency, or high level source code containing a conditional store operation, which would lead to a control-flow dependency in a traditional compiler. The algorithm produces as output functionally equivalent code without a control-flow dependency, thereby eliminating branches which could lead to branch mispredictions and stalls in pipelining computer architectures which are not fully predicated. Since the algorithm is applicable to computer architectures which are not fully predicated, and does not require predicates in the code, the algorithm produces code which uses far less resources than full predication. The algorithm is applicable to architectures supporting operations such as simple conditional move (cmov) operations, select operations, or any other analogous operation now existing or which may be created in the future.

The efficient algorithm implements conditional store operations using speculative stores rather than branches with speculatively executed operations. In other words, a data-flow dependency (which avoids branches by implementing a speculative store) is generated by a compiler using the algorithm rather than a control-flow dependency (which uses a branch to implement the conditional store), through a process known in fully predicated architectures as if-conversion.

The compiler algorithm to implement speculative stores can be adapted to various types of input and output code, whether high level or low level code, and for any computer programming language. The importance of the algorithm lies in its ability to convert or avoid control-flow dependencies and produce data-flow dependencies to implement conditional store operations which do not require branch operations. Thus, branch mispredictions and execution stalls are greatly reduced for pipelining architectures. The algorithm can be implemented in any suitable software tool, such as a compiler, assembler, or optimizer.

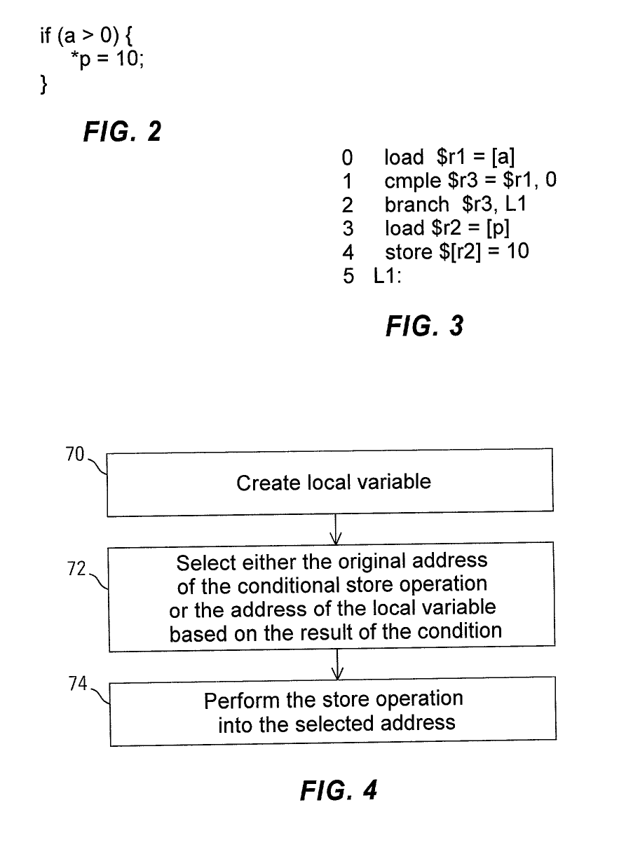

The compiler algorithm to implement speculative stores will be described below as it can be used to transform the exemplary code fragments illustrated in FIGS. 2 and 3. The code fragment illustrated in FIG. 2 contains high level source code written in the C programming language for performing a conditional store operation, as follows:

if (a > 0) {

*p = 10;

}

As described above, the value 10 is conditionally stored at the address pointed to by p only if the condition (a>0) is satisfied, that is, only if a has a value greater than zero.

The code fragment illustrated in FIG. 3 contains a low level pseudo-Assembly language version of the exemplary code fragment of FIG. 2, as it would be created by a traditional compiler from the code of FIG. 2. The code fragment of FIG. 3 performs the conditional store operation using a branch, thus including a control-flow dependency, as follows:

| | | |
|---|---|---|
| 0 | load $r1 = [a] | # # read value of a in reg $r1 |
| 1 | cmple $r3 = $r1, 0 | # # compare a <= 0 |
| 2 | branch $r3, L1 | # # if a not > 0 (a <= 0) goto L1 |
| 3 | load $r2 = [p] | # # read value of p in reg $r2 |
| 4 | store [$r2] = 10 | # # store 10 in address pointed |
| | | # # to by p |

The pseudo-Assembly code instructions used herein function as follows:

| Pseudo-Assembly | Result |
|---|---|
| load t = [a] | t = memory [a] |
| store [a] = x | memory [a] = x |
| move t = x | t = x |
| cmov i = j, k | if (j) i = k |
| select i = j ?k, l | if (j) i = k else i = l |
| cmpgt t = r1, r2 | if (r1 > r2) t = 1 else t = 0 |
| cmple t = r1, r2 | if (r1 <= r2) t = 1 else t = 0 |
| branch x, L | if x then goto L |

Line 0 of the code above loads the value of a into the processor register number 1. Line 1 tests the branch condition by comparing the value of a (as it appears in register 1) to zero. Line 1 sets register 3 to true if a is less than or equal to zero, or false if a is greater than zero. Line 2 branches to label L1 on line 5 if the value in register 3 is true, meaning that a was not greater than zero, thereby bypassing the store instruction performed by lines 3 and 4. If, on the other hand, the value in register 3 is false, meaning that a was greater than zero, execution continues past the branch to line 3. Line 3 loads the address pointed to by p into register 2. Line 4 stores the value 10 into the address pointed to by p as contained in register 2. Line 5 contains label L1, enabling the branch operation in line 2 to bypass the store instruction performed by lines 3 and 4. This code segment contains a control-flow dependency, which causes problems if the wrong branch is predicted during execution in a computer with a pipelining architecture. If the processor predicts that a will be greater than zero and that the path straight through the branch will be the actual path through the code when it is executed, the processor will fetch the instructions in lines 3 and 4, placing them in the pipeline. If a turns out not to be greater than zero, the branch will have been mispredicted and the pipeline will improperly contain lines 3 and 4. The processor must therefore clear the pipeline and undo any effects caused by placing lines 3 and 4 in the pipeline, causing execution to stall. Thus, the traditionally compiled version of the code in FIG. 2 is not ideal for execution on a computer with a pipelining architecture that is not fully predicated.

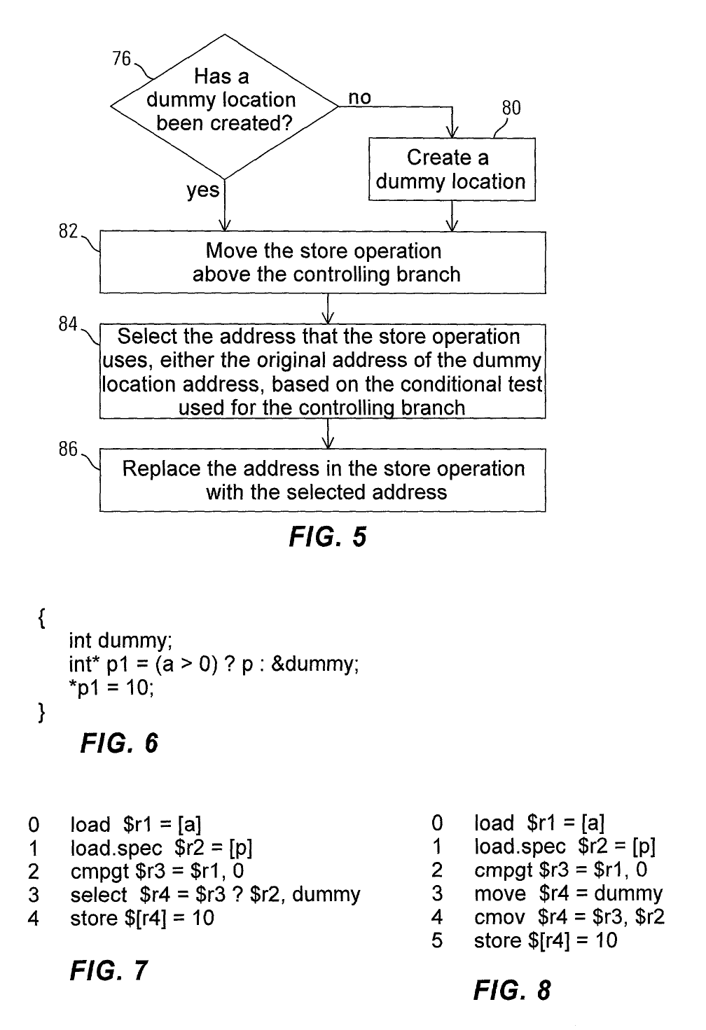

Referring now to FIG. 5, an exemplary compiler algorithm to implement speculative stores will be described generally. The algorithm is preferably applied in a compiler to process high level source code containing a conditional store operation in order to create functionally equivalent code (either high or low level) with a data-flow dependency. The compiler creates 70 a dummy location, or local variable, for each compilation unit, as described above with respect to the first exemplary embodiment. For subsequent executions of the algorithm in the same function or compilation unit, the previously created local variable can be reused.

For a given conditional store operation in the compilation unit, the compiler selects 72 either the original address of the conditional store operation or the dummy address based on the result of the condition. If the condition is satisfied, the compiler selects 72 the original address of the conditional store operation. If the condition is not satisfied, the compiler selects 72 the address of the local variable. That is, the compiler creates code that, when executed, will select the original address if the condition is satisfied, or the address of the local variable if the condition is not satisfied.

The compiler then creates code that performs 74 the store operation into the selected address. Thus, the compiler generates code with a data-dependency and no branch. This avoids the effects of branch mispredictions in computer architectures which are not fully predicated for code blocks having conditional memory write operations.

Note that the actual result of the condition controlling the store operation will not be known at compile time, so the selection 82 of the address must be included in the generated code. However, each instruction generated by the compiler will be executed, since there is no control-flow dependency or branch operation. Thus, the generated code does not lead to mispredicted branches or execution stalls. During execution of the generated code, the processor will not be able to determine the result of the condition until the condition test instruction is actually executed, so the code has a data-flow dependency. This means that the processor may have to execute the instructions in the order produced by the compiler, but this is much more easily dealt with by the compiler and a pipelining processor, and aggressive scheduling techniques can be applied to execute the code rapidly.

Referring now to FIG. 5, the compiler algorithm to implement speculative stores will be described in more detail. The algorithm is described here as it could be applied to an if-conversion optimization pass in the compiler after the compiler has generated code containing a control-flow dependency to implement a conditional store operation. Thus, the compiler would have processed high level source code such as that shown in FIG. 2 to generate low level assembly code such as that shown in FIG. 3, which contains a controlling branch operation.

Alternatively, the algorithm may be adapted and applied directly to high level code containing a condition store operation for which no branch has been generated.

If a dummy location has not been created 76, the compiler first creates 80 (FIG. 5) a dummy location for each compilation unit. In other words, for each file processed by the compiler, the compiler creates 80 a variable with local linkage which is only visible or accessible within the current file being processed. The dummy location should be of adequate size and alignment to contain any of the possible data types used in conditional store operations throughout the compilation unit, since it is reused each time the algorithm is executed. Note also that since the compiler only needs to generate one dummy location for each compilation unit, the algorithm omits the step of creating the dummy location for subsequent conditional store operations in the compilation unit.

For a given conditional memory write, or store, operation in the compilation unit, the compiler then moves 82 the store operation above the controlling branch.

The compiler selects 84 the address that the store operation uses, either the original address or the address of the dummy location, based on the conditional test used for the controlling branch. Thus, the compiler selects the dummy location for one conditional result, or the original store location for the other conditional result. For example, if the condition is satisfied, the address selected for the store operation to use is the original destination address. If the condition is not satisfied, in other words if it is false, the address selected for the store operation to use is the dummy location. This selection 84 can be performed, for example, by setting a pointer either to the original address or the address of the dummy location using the conditional test used for the controlling branch.

The compiler then replaces 86 the address in the store operation with the selected address. This replacement can be performed by storing to the address indicated by the pointer used in the selection 84 above. Thus, the destination address for the store operation is speculative, and the compiler algorithm has replaced a control-flow dependency containing a branch) with a data-flow dependency (containing a speculative store).

The transformed versions of the exemplary code segments of FIGS. 2 and 3 will now be discussed, as they could be transformed by the compiler algorithm to implement speculative stores. Referring now to FIG. 6, the following exemplary converted code fragment illustrates a high level equivalent of a transformed version of the code fragment of FIG. 2:

{

int dummy;
int* p1 = (a > 0) ? p : &dummy
*p1 = 10;

}

&dummy;

As in the code of FIG. 2, the value 10 is conditionally stored at the address pointed to by p only if the condition (a>0) is satisfied, that is, only if a has a value greater than zero. However, this code segment would not lead to a control-flow dependency in a traditional compiler, since it is the selection of the address pointed to by p1 which is dependent on the result of the condition (a>0), note the store operation. The local variable dummy is created 80 in the first line. In the second line, the address pointed to by p1 is selected based on the condition (a>0). If (a>0) evaluates as true, p1 points to the same address as p. If (a>0) evaluates as false, p1 points to the address of the local variable dummy. Finally, in the third line the value 10 is stored 84 at the selected address.

Note that including the efficient algorithm to implement speculative stores in a compiler prevents the compiler from generating a control-flow dependency from the code illustrated in FIG. 2. Thus, the programmer does not need to manually write the code illustrated in FIG. 6, but can write the simpler and more typical code illustrated in FIG. 2. The compiler algorithm will generate efficient low level code as if the source code were in the form illustrated in FIG. 6, even if it was actually in the form illustrated in FIG. 2.

As shown in FIG. 7, the following pseudo-Assembly language version of the exemplary converted code fragment of FIG. 6 illustrates the removal of the control-flow dependency using a “select” operation:

| | | |
|---|---|---|
| 0 | load $r1 = [a] | # # read value of a in reg $r1 |
| 1 | load.spec $r2 = [p] | # # spec read p in reg $r2 |
| 2 | cmpgt $r3 = $r1, 0 | # # compare a > 0 in reg $r3 |
| 3 | select $r4 = $r3 ? $r2, dummy | # # r4 = (a > 0)? r2,<dummy> |
| 4 | store $ [r4] = 10 | # # speculatively store 10 |

Line 0 of the code above loads the value of a into the processor register number 1. Line 1 reads the address pointed to by p into register 2. The use of the “speculative load” operation helps the pipelining processor use aggressive scheduling techniques, but does not affect the analysis of the code's logic. Line 2 uses the “compare greater than” operation, setting register 3 to true if a is greater than zero, or false if a is less than or equal to zero. Line 3 uses the “select” operation to select the address pointed to by register 4. If register 3 is true, meaning that a was greater than zero, the address pointed to by p is stored in register 4. If register 3 is false, meaning that a was not greater than zero and the condition was not satisfied, the address of the dummy location is stored in register 4. Line 4 stores the value 10 into the address contained in register 4. This code segment contains a data-flow dependency, since the address used by the store operation is dependent upon the condition (a>0). The code uses the “select” operation to perform the speculative store, avoiding a branch operation.

As shown in FIG. 8, the following pseudo-Assembly language version of the exemplary converted code fragment of FIG. 6 illustrates the removal of the control-flow dependency using a “conditional move” operation:

| | | |
|---|---|---|
| 0 | load $r1 = [a] | # # read value of a in reg $r1 |
| 1 | load.spec $r2 = [p] | # # spec read p in reg $r2 |
| 2 | cmpgt $r3 = $r1, 0 | # # compare a > 0 in req $r3 |
| 3 | move $r4 = dummy | # # load dummy in reg $r4 |
| 4 | cmov $r4 = $r3, $r2 | # # if (a > 0) $r4 = p |
| 5 | store $ [r4] = 10 | # # speculatively store 10 |

Line 0 of the code above loads the value of a into the processor register number 1. Line 1 reads the address pointed to by p into register 2. Again, the use of the “speculative load” operation helps the pipelining processor use aggressive scheduling techniques, but does not affect the analysis of the code's logic. Line 2 uses the “compare greater than” operation, setting register 3 to true if a is greater than zero, or false if a is less than or equal to zero. Line 3 moves the address of the dummy location into register 4. Line 4 uses the “cmov” operation to conditionally overwrite the address of the dummy location in register 4 with the address pointed to by p, as it is stored in register 2. If register 3 holds the value true, meaning that a was greater than zero, register 4 is overwritten with the address pointed to by p. If register 4 holds the value false, meaning that a was not greater than zero, the “cmov” operation does nothing, leaving the address of the dummy location in register 4. Line 5 stores the value 10 into the address contained in register 4. This code segment contains a data-flow dependency, since the address used by the store operation is dependent upon the condition (a>0). The code uses the “cmov” operation to perform the speculative store, avoiding a branch operation.

Again, the compiler algorithm to implement speculative stores can use any suitable instructions or operations to implement the speculative store in order to avoid control-flow dependencies, and is not limited to the “select” and “cmov” operations discussed above.

The exemplary compiler algorithm to implement speculative stores is a local algorithm that performs a legal transformation for the conditional store instruction, so that multiple conditional store instructions can be moved above a controlling branch instruction one by one. The algorithm transforms the following type of code, where instructions A, B, C and D are controlling branch instructions:

Y
if (x) {

A
B
C
D

}
Z

The compiler performs if-conversion on the code above, using the algorithm to implement speculative stores, generating the following:

Y

A′

B′

C′

D′

if (x) {

}

Z

After the compiler has performed a dead-code removal pass, the transformed code above becomes the following, with no branches:

Y

A′

B′

C′

D′

Z

The compiler realizes that the “if (x){ }” branch is dead and removes it through a dead-code removal pass during the compilation process. Similar techniques can be used for more complex conditionals or more complex control blocks such as if-then-else blocks. The compiler algorithm to implement speculative stores can thus be adapted to remove any type of control-flow dependencies containing a conditional memory write operation.

For example, the compiler algorithm to implement speculative stores can be adapted to transform the following if-then-else case:

if (x > 0) {

*p = 1; /* A */
*q = 2; /* B */

}
else {

*p = 3; /* C */

}

The transformed version, in C, appears as follows:

*((x>0) ? p : &dummy)=1; /* A */

*((x>0) ? q : &dummy)=2; /* B */

*((x>0) ? &dummy : p)=3; /* C */

The transformed version, in pseudo-Assembly code, appears as follows:

| cmpgt $b = x, 0 | |
|---|---|
| select $tp1 = $b ? p : &dummy | |
| select $tp2 = $b ? &dummy : p | |
| select $tq = $b ? q : &dummy | |
| store [$tp1] = 1 | # # A |
| store [tp2] = 2 | # # B |
| store [$tq] = 3 | # # C |

Note that in general it is not possible to change the order of the store operations. If the compiler has additional information (such as the knowledge that p and q point to a non-overlapping memory, i.e., that they cannot alias), it can simplify A and C by collapsing them into one store instruction as follows:

*((x>0) ? q : &dummy)=2; /* B */

*p=(x>0) ? 1 : 3; /* A & C together */

In pseudo-Assembly, the simplified transformed code appears as follows:

cmpgt $b=x, 0

select $tv=$b ? 1 : 3

select $tq=$b ? q : &dummy

store [p]=$tv ## A & C

store [$tq]=2 ## B

Although the phrase “compiler algorithm to implement speculative stores” has been used extensively throughout the description above, it is important to note that the algorithm is not limited to use in a compiler. As mentioned above, the algorithm could alternatively be implemented in an assembler, an optimizer, or any other tool which can detect a control-flow dependency caused by a conditional store operation and which can create a dummy location and transform the code as described above. Software tools other than a compiler, such as an assembler or optimizer, may need to use techniques for create the dummy location which are different than the technique used by a compiler.

However, the preferred embodiment of the compiler algorithm to implement speculative stores uses a compiler, as this is the most direct way to allow programmers to use high level languages without generating control-flow dependencies for conditional write operations. The details of how to include the algorithm in a compiler is dependent upon the design of the compiler, and in particular upon the details of the generic if-conversion algorithm in the compiler. However, one skilled in the art of compiler design or design of similar computer tools will be able to adapt the efficient algorithm to implement speculative stores to any particular compiler or software tool.

The compiler algorithm to implement speculative stores has been described as it applies to conditional write operations having two possible outcomes or results for the condition. The algorithm may be easily extended or nested to accommodate conditions having more than two outcomes, and is not limited to the exemplary conditions discussed above.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. Apparatus for transforming computer software, said computer software comprising a branch operation for conditionally bypassing a memory write operation, the apparatus comprising:
a. one or more computer readable storage media; and
b. computer executable program code stored in the one or more computer readable storage media, the computer executable program code comprising:
i. code for creating a storage location;
ii. code for moving said memory write operation above said branch operation;
iii. code for selecting a target address for said memory write operation, wherein said storage location is selected if said branch operation bypasses said memory write operation; and
iv. code for replacing an original address in said memory write operation with said target address.

2. The apparatus of claim 1, wherein said code for selecting said target address selects said original address if said branch operation does not bypass said memory write operation.

3. The apparatus of claim 1, wherein said code for creating, moving, selecting and replacing transforms said computer software into low level program code for performing a conditional memory write without a branch operation.

4. The apparatus of claim 3, wherein said low level program code is functionally equivalent to said computer software.

5. The apparatus of claim 3, wherein said low level program code comprises Assembly code.

6. The apparatus of claim 3, wherein said low level program code comprises machine language code.

7. The apparatus of claim 1, wherein said computer executable program code comprises a compiler.

8. The apparatus of claim 1, wherein said computer executable program code comprises an assembler.

9. The apparatus of claim 1, wherein said code for creating said storage location comprises code for creating computer executable instructions which generate one storage location per compilation unit.

10. The apparatus of claim 1, wherein said code for selecting said target address for said memory write operation comprises a select operation.

11. The apparatus of claim 1, wherein said code for selecting said target address for said memory write operation comprises a conditional move operation.

12. Apparatus for transforming computer software, said computer software comprising a conditional memory write operation, the apparatus comprising:
a. one or more computer readable storage media; and
b. computer executable program code stored in the one or more computer readable storage media, the computer executable program code comprising:
i. code for creating a local variable;
ii. code for selecting either an original address of said conditional memory write operation or an address of said local variable; and
iii. code for performing a memory write operation into said selected address.

13. The apparatus of claim 12, wherein said computer executable program code comprises a compiler.

14. The apparatus of claim 12, wherein said code for selecting bases said selection on a result of a condition in said conditional memory write operation.

15. The apparatus of claim 14, wherein said code for selecting selects said address of said local variable if said condition is not satisfied.

16. The apparatus of claim 12, wherein said computer software is written in a high level language, and wherein said code for creating, selecting, and performing transforms said computer software into low level program code for performing a speculative store.

17. The apparatus of claim 16, wherein said low level program code is functionally equivalent to said computer software.

18. The apparatus of claim 16, wherein said low level program code contains no control-flow dependencies.

19. The apparatus of claim 16, wherein said low level program code comprises Assembly code.

20. The apparatus of claim 16, wherein said low level program code comprises machine language code.

21. Apparatus for transforming computer software, comprising:
means for reading source code, wherein said source code includes a conditional memory write operation; and
means for generating functionally equivalent code from said source code, wherein said functionally equivalent code contains a data-flow dependency, and wherein said functionally equivalent code is not fully predicated.
